(19) United States
(12) Patent Application Publication
(10) Pub. No.: US 2005/0199113 A1
(43) Pub. Date: Sep. 15, 2005

(54) Mechanism for titling and height adjusting circular blade of circular saw machine

(75) Inventors: George Ku, Taichung Hsien (TW); Eric Lo, Taichung Hsien (TW)

Correspondence Address: BACON & THOMAS, PLLC, 625 SLATERS LANE, FOURTH FLOOR, ALEXANDRIA, VA, 22314, US

(73) Assignee: REXON INDUSTRIAL CORP., LTD., Taichung Hsien (TW)

(21) Appl. No.: 10/795,223

(22) Filed: Mar. 9, 2004

(51) Int. Cl. B23D 45/06

(52) U.S. Cl. 83/473; 83/477.2

(57) ABSTRACT

A circular saw machine includes a blade mechanism which includes a circular blade extending through a slot defined through the worktable of the saw machine. A mechanism for tilting the circular blade mechanism includes a wheel located outside of the front wall of the base and drives two matched bevel gears. One of the two bevel gears is engaged with a curve rack of the blade mechanism so that the blade mechanism together with the blade are pivoted an angle.

### FIELD OF THE INVENTION

The present invention relates to a mechanism for tilting and controlling the height above the worktable of the circular blade of a circular saw machine.

### BACKGROUND OF THE INVENTION

A conventional circular saw machine 10 is disclosed in FIGS. 1 and 2A, and generally includes a base 11 with a worktable 12 on a top of the base 11. A blade mechanism 14 is received in the base 11 and the circular blade 13 of the blade mechanism 14 extends through a slot defined through the worktable 12. A tilt control device includes a first wheel 16 and a threaded rod 17 which is driven by the first wheel 16 which is located outside of the side wall 112 of the base 11. The blade mechanism 14 is fixed to a transmitting gear set 18 which is connected to the threaded rod 17 so that when rotating the first wheel 16, as shown in FIG. 2B, the transmitting gear set 18 drives the blade mechanism 14 to tilt an angle. A height adjustment device includes an operation rod 19 which is connected to the blade mechanism 14 and one end of the operation rod 19 extends through the front wall of the base 11 and is connected to a second wheel 15. The operation rod 19 movably extends through a curve slot 113 defined through the front wall 111 of the base 11. The operation rod 19 moves along the curve slot 113 when the blade mechanism 14 is tilted. The blade 13 can be raised or lowered by rotating the second wheel 15.

The user has to check the angle that the blade 13 tilts by observing the scales marked along the curve slot 113 on the front wall 111. The user has to bend to check the scale marks which is located below the worktable 12. Accordingly, it takes several times to operate the first wheel 16 on the side wall 112 and the second wheel 15 on the front wall 11 and check the scale marks. The two wheels 15, 16 are located at different side walls so that it is inconvenient for the user to operate them. Besides, foreign objects could be inserted into the curve slot 113 defined through the front wall 111.

The present invention intends to provide a mechanism that includes two wheels on the front wall of the base and a cover always covers the curve slot to prevent foreign objects from being inserted in the curve slot.

### SUMMARY OF THE INVENTION

The present invention relates to a circular saw machine which comprises a base and a worktable connected to a top of the base. A blade mechanism is received in the base and includes a circular blade which extends through a slot defined through the worktable. A curve rack is connected to the blade mechanism. A tilt control device includes a rod and a first worm gear is mounted to the rod. The first worm gear is engaged with the curve rack of the blade mechanism. A first wheel located outside of a front wall of the base is connected to a first shaft which rotatably extends through the front wall of the base. A first bevel gear is connected to the first shaft and engaged with a second bevel gear mounted to the rod.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of a conventional circular saw machine;

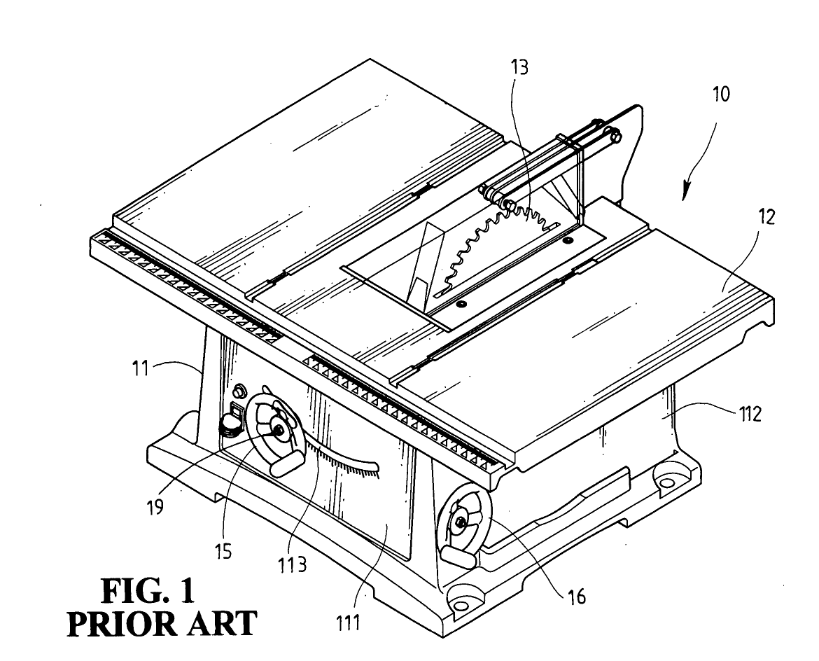

FIG. 2A is a side view to show the tilt control device connected to the circular blade mechanism of the conventional circular saw machine;

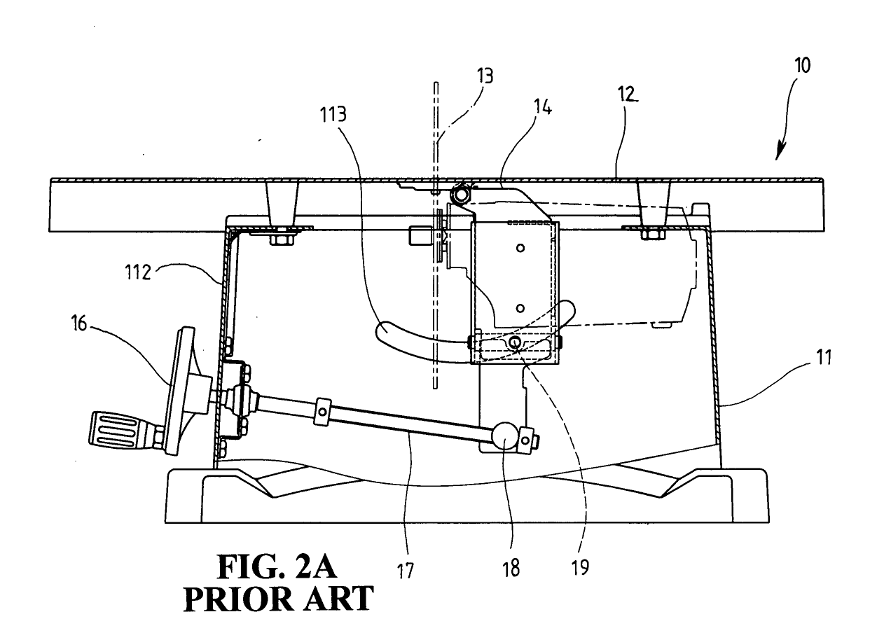

FIG. 2B is a side view to show the circular blade mechanism of the conventional circular saw machine tilts by operating the first wheel;

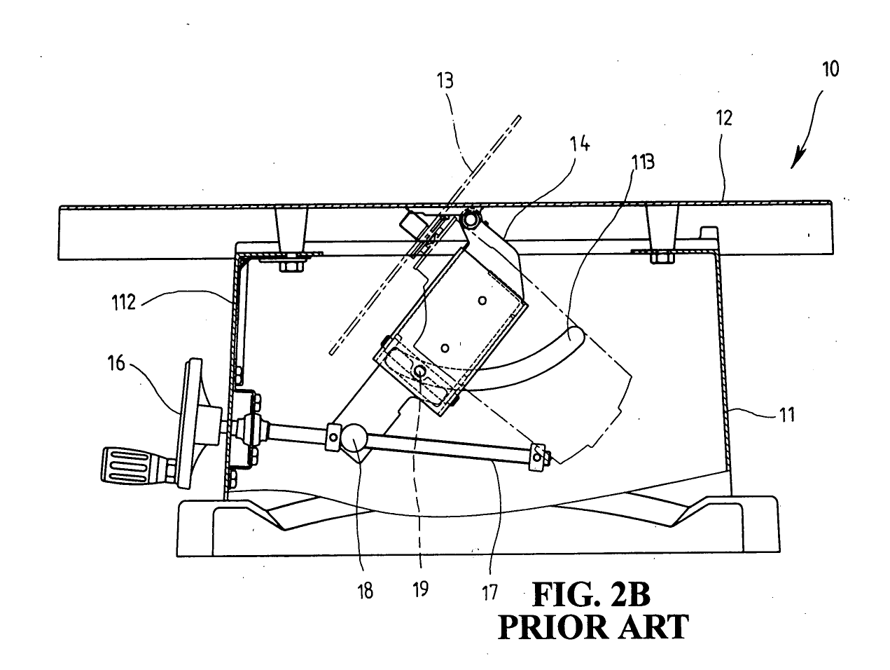

FIG. 3 is a perspective view of the circular saw machine of the present invention;

FIG. 4 is an exploded view to show the mechanism for tilting and controlling the height above the worktable of the circular blade of the present invention;

FIG. 5 is a perspective view to show the mechanism for tilting and controlling the height above the worktable of the circular blade of the present invention;

FIG. 6 is a top view to show the locations of the mechanism and the blade;

FIG. 7 is a front view to show the mechanism of the present invention, and

FIG. 8 shows that the blade mechanism is tilted by operating the mechanism of the present invention.

### DETAILED DESCRIPTION OF THE PREFERRED EMBODIMENT

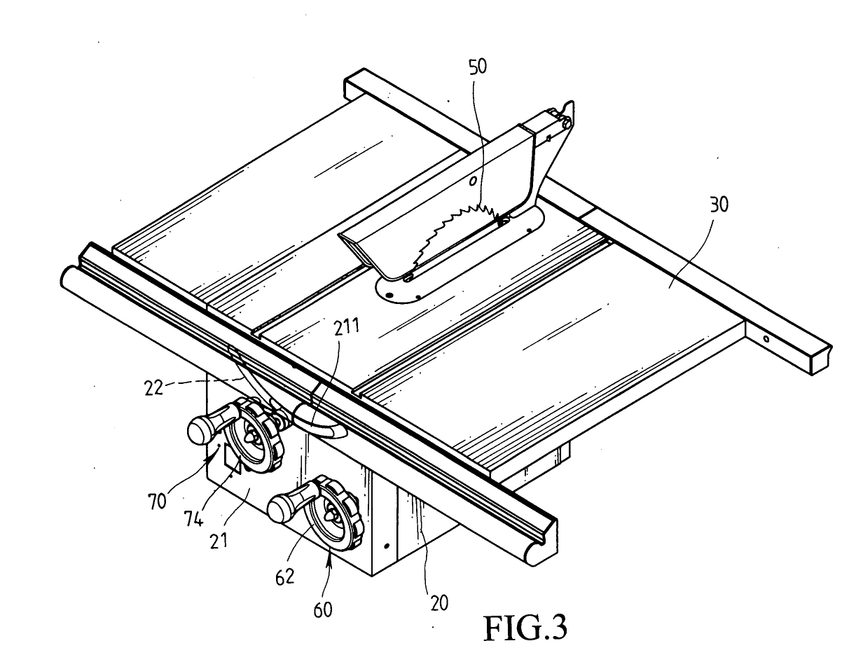

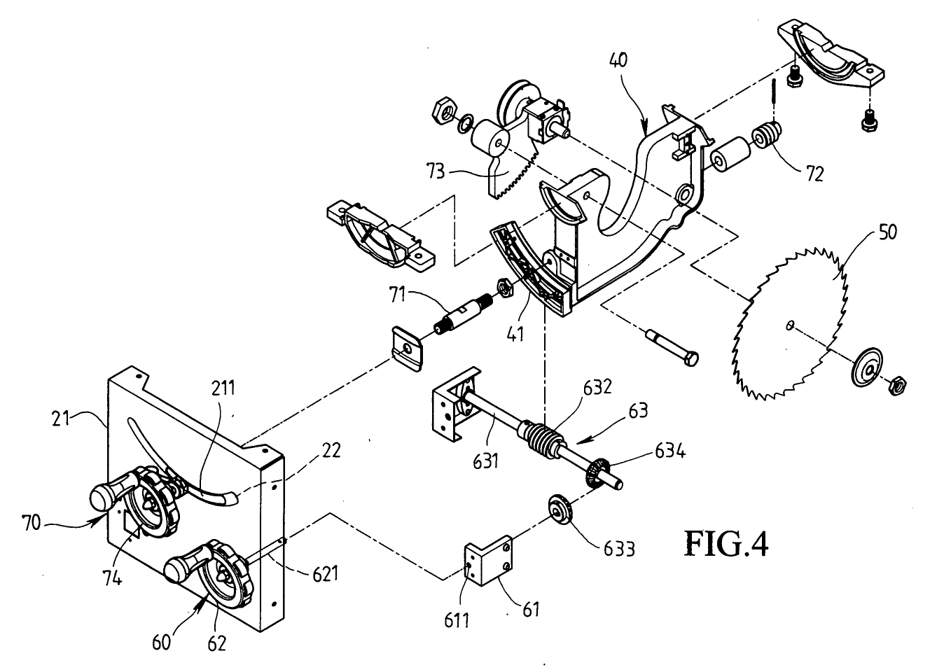

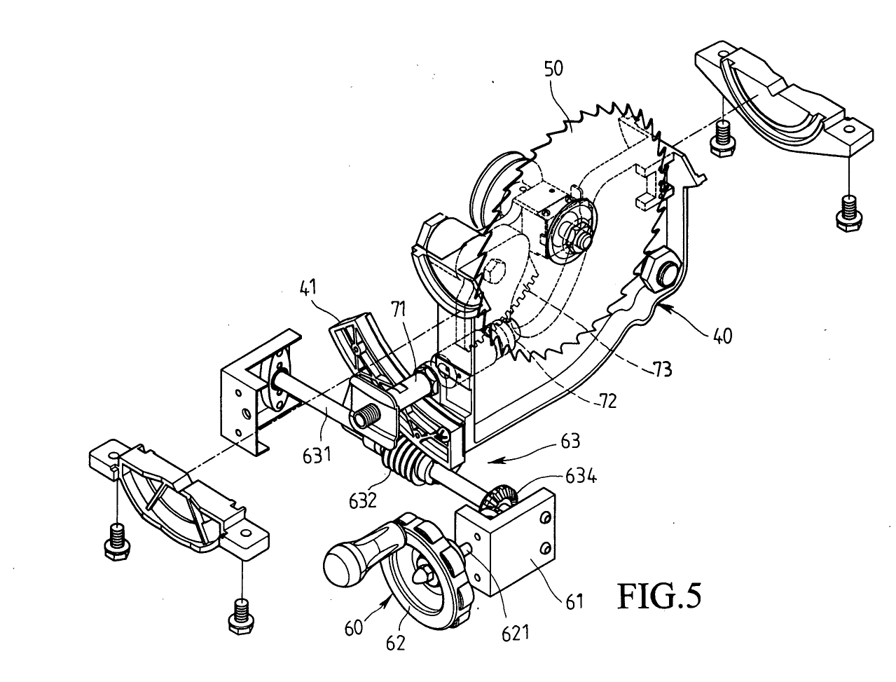

Referring to FIGS. 3 to 5, the circular saw machine of the present invention comprises a base 20 and a worktable 30 is connected to a top of the base 20. A slot and is defined through the worktable 30 so that a circular blade 50 of a blade mechanism 40 extends through the slot through the worktable 30. The blade mechanism 40 is received in the base 20.

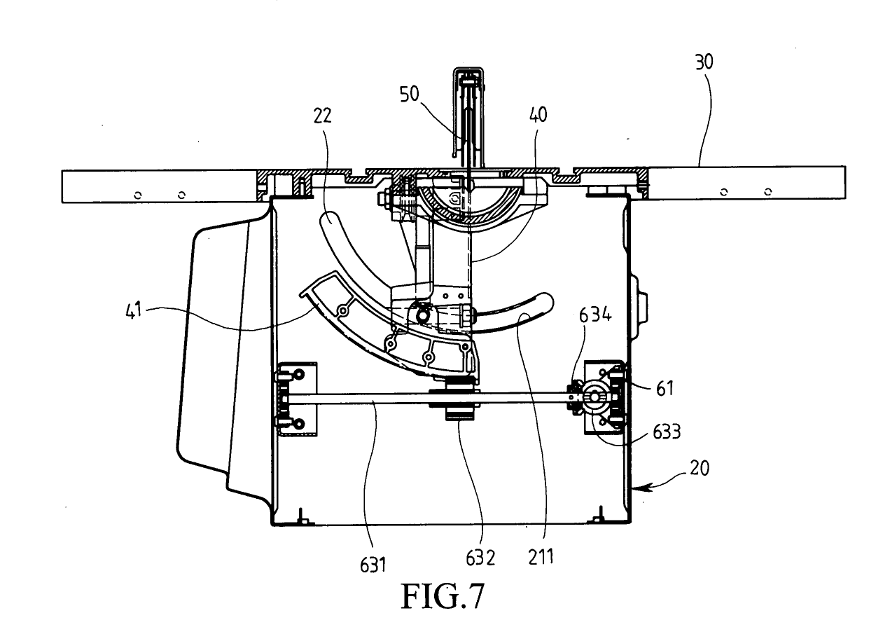

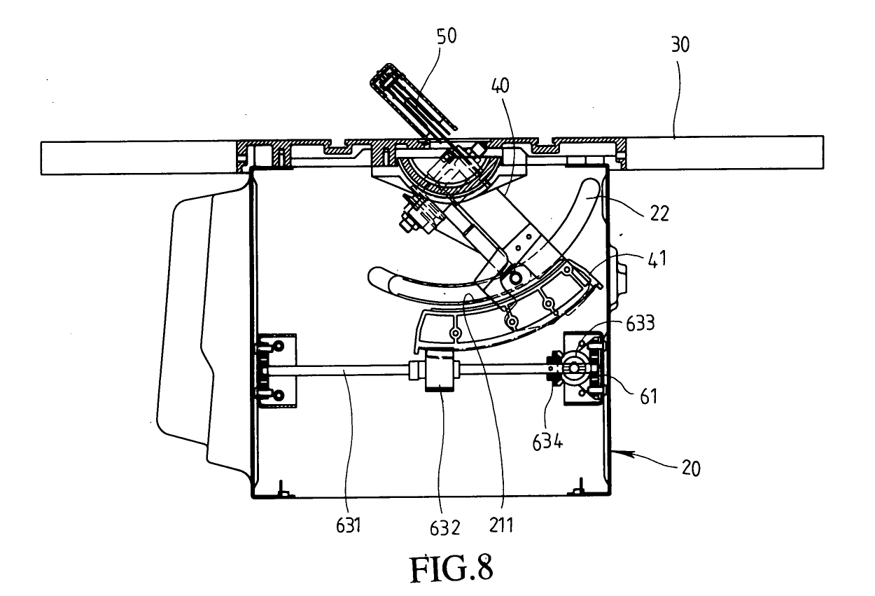

Further referring to FIG. 7, a tilt control device 60 includes a first wheel 62 which is located outside of a front wall 21 of the base 20 and connected to a first shaft 621 which extends through the front wall 21 of the base 20. Two frames 61 are connected to two opposite insides of the base 20 and the first shaft 621 rotatably extends through a hole 611 one of the two frames 61. A first bevel gear 633 is connected to a distal end of the first shaft 621. A transmitting assembly 63 includes a rod 631 which is rotatably between the two frames 61 and a first worm gear 632 is mounted to the rod 631. A second bevel gear 634 is mounted to the rod 631 and is matched with the first bevel gear 633 so that when the first wheel 62 is rotated, the rod 631 and the first worm gear 632 are rotated. The first worm gear 632 is engaged with a curve rack 41 of the blade mechanism 40. Referring to FIG. 8, the first worm gear 632 drives the curve rack 41 when the first wheel 62 is rotated, and the blade mechanism 40 together with the blade 50 are tilted.

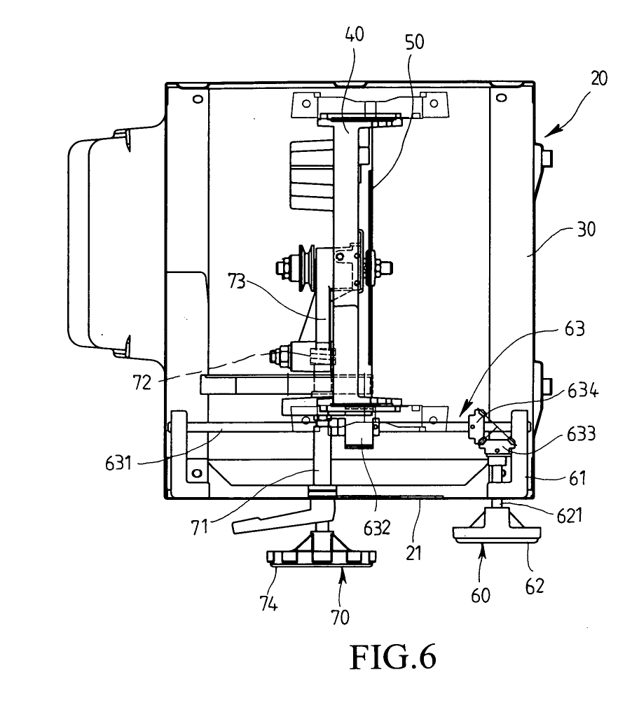

Further referring to FIG. 6. a height adjustment device 70 includes a second shaft 71 which has one end movably extends through a curve slot 211 defined through the front wall 21 of the base 20 and a second end of the second shaft 71 is connected to a second worm gear 72. The second worm gear 72 is engaged with a curve rack plate 73 that is connected to the blade mechanism 40. A second wheel 74 is connected to the end of the second shaft 71 that extends through the curve slot 211 and located outside of the front wall 21 of the base 20. The first wheel 62 and the second wheel 74 are both located at the front wall 21 so that the user is convenient to operate the two wheels 62 and 74. When rotating the second wheel 74, the second worm gear 72 drives the curve rack plate 73 to lower or raise the position of the blade 50. A retractable cover 22 is connected to an inside of the front wall 21 and always covers the curve slot 211 regardless of the position of the second shaft 71 which extends through the retractable cover 22.

While we have shown and described the embodiment in accordance with the present invention, it should be clear to those skilled in the art that further embodiments may be made without departing from the scope of the present invention.

1. A circular saw machine comprising:
a base and a worktable connected to a top of the base, a slot defined through the worktable;
a blade mechanism received in the base and including a circular blade which extends through the slot through the worktable, and
a tilt control device connected to the blade mechanism and including a first wheel which pivots the blade mechanism, the first wheel located outside of a front wall of the base, a height adjustment device connected to the blade mechanism and including a second wheel so as to adjust the blade mechanism to extend above the worktable, the second wheel located outside of the front wall of the base.

2. The circular saw machine as claimed in claim 1, wherein the blade mechanism includes a curve rack and the tilt control device includes a rod and a first worm gear mounted to the rod, the first worm gear engaged with the curve rack of the blade mechanism.

3. The circular saw machine as claimed in claim 2, wherein the first wheel is connected to a first shaft which rotatably extends through the front wall of the base, a first bevel gear connected to the first shaft and engaged with a second bevel gear mounted to the rod.

4. The circular saw machine as claimed in claim 3 further comprising two frames connected to two opposite insides of the base and the rod rotatably connected between the two frames, the first shaft connected to the first wheel and rotatably extending through one of the two frames.

5. The circular saw machine as claimed in claim 1, wherein the height adjustment device includes a second shaft extending through a curve slot defined through the front wall of the base, a second worm gear connected to an end of the second shaft and engaged with a curve rack plate which is connected to the blade mechanism, the second wheel connected to the other end of the second shaft.

6. The circular saw machine as claimed in claim 5 further comprising a retractably cover connected to an inside of the front wall of the base and the second shaft extending through the retractable cover.
